(19) United States
(12) Patent Application Publication
(10) Pub. No.: US 2025/0005258 A1
(43) Pub. Date: Jan. 2, 2025

(54) INFORMATION PROCESSING METHOD AND SYSTEM, DEVICE, AND MEDIUM

(71) Applicant: Beijing Zitiao Network Technology Co., Ltd., Beijing (CN)

(72) Inventors: Xiang Jiang, Beijing (CN); Runqiong Wang, Beijing (CN); Yang Chen, Beijing (CN); Zhaoyuan Peng, Beijing (CN)

(21) Appl. No.: 18/883,992

(22) Filed: Sep. 12, 2024

(30) Foreign Application Priority Data
Sep. 22, 2023 (CN) 202311235567.2

(51) Int. Cl. G06F 40/10; G10L 15/26

(52) U.S. Cl. CPC G06F 40/10; G10L 15/26

(57) ABSTRACT

This application provides an information processing method and system, a device, and a medium. The method includes: providing a first control associated with a speech input interface, where the speech input interface is displayed with a first text, and the first text is obtained by converting a first speech input; and displaying a second text on the speech input interface in response to an operation associated with the first control, where the second text is obtained by processing the first text based on a processing process corresponding to the first control.

### CROSS-REFERENCE TO RELATED APPLICATION(S)

This application claims priority to Chinese Application No. 202311235567.2 filed on Sep. 22, 2023, the disclosure of which is incorporated herein by reference in its entity.

### FIELD

This application relates to the field of computer technology, and particularly to an information processing method and system, an electronic device, and a computer-readable storage medium.

### BACKGROUND

With the continuous development of computer technology, the application range of a natural language processing (NLP) technology has gradually expanded, and speech input based on speech recognition has emerged. Speech input can convert a speech signal input by a user into a text, such that the user does not need to input the text through a keyboard, thereby bringing convenient interactive experience to the user.

### SUMMARY

This application provides an information processing method. According to the method, by providing a control associated with a speech input interface, a user may automatically process, based on needs, a text obtained after speech recognition, thereby improving operation efficiency and interactive experience. This application further provides a system, an electronic device, a computer-readable storage medium, and a computer program product corresponding to the above method.

In a first aspect, this application provides an information processing method, including:
providing a first control associated with a speech input interface, where the speech input interface is displayed with a first text, and the first text is obtained by converting a first speech input; and
displaying a second text on the speech input interface in response to an operation associated with the first control, where the second text is obtained by processing the first text based on a processing process corresponding to the first control.

In a second aspect, this application provides an information processing system, including:
a providing module, configured to provide a first control associated with a speech input interface, where the speech input interface is displayed with a first text, and the first text is obtained by converting a first speech input; and
a display module, configured to display a second text on the speech input interface in response to an operation associated with the first control, where the second text is obtained by processing the first text based on a processing process corresponding to the first control.

In a third aspect, this application provides an electronic device. The electronic device includes a processor and a memory. The processor and the memory are in mutual communication. The processor is used to execute instructions stored in the memory to enable the electronic device to perform the information processing method in the first aspect or any of implementations of the first aspect.

In a fourth aspect, this application provides a computer-readable storage medium. The computer-readable storage medium stores instructions. The instructions indicate an electronic device to perform the information processing method in the first aspect or any of implementations of the first aspect.

In a fifth aspect, this application provides a computer program product including instructions. The computer program product, when running on an electronic device, enables the electronic device to perform the information processing method in the first aspect or any of implementations of the first aspect.

Based on the implementations provided in the above various aspects of this application, further combination may be performed to provide more implementations.

### BRIEF DESCRIPTION OF THE DRAWINGS

To describe technical methods in embodiments of this application more clearly, the accompanying drawings required for use in the embodiments will be briefly described below.

FIG. 1 is a schematic flowchart of an information processing method according to an embodiment of this application;

FIGS. 2A to 2E are schematic diagrams of a speech input interface according to an embodiment of this application;

FIG. 3 is a structural schematic diagram of an information processing system according to an embodiment of this application; and

FIG. 4 is a structural schematic diagram of an electronic device according to an embodiment of this application.

### DETAILED DESCRIPTION OF EMBODIMENTS

Terms “first” and “second” in embodiments of this application are merely used for the description purpose but not understood as indicating or implying relative importance or implicitly indicating the number of indicated technical features. Therefore, features defined with “first” and “second” may explicitly or implicitly include one or more of the features.

Firstly, some technical terms involved in the embodiments of this application are introduced.

With the continuous development of computer technology, the application range of the natural language processing (NLP) technology has gradually expanded, and an interaction mode between a user and a computing device is gradually developed from a graphical user interface (GUI) to a language user interface (LUI).

Specifically, the user may perform speech input through the LUI. After receiving a speech signal input by the user, the computing device may perform speech recognition to convert the speech signal into a text. Therefore, the user does not need to input the text through a keyboard, thereby bringing convenient interactive experience to the user.

However, there may be recognition errors in the process of speech input. When the user inputs a long speech, a text obtained after speech recognition is likely to cause cases such as duplication, redundancy, a loose structure, and an unclear organization, which leads to the need for the user to manually modify the text, making it difficult to effectively improve the operation efficiency and interactive experience.

In addition, with the rapid development of computer technology, office automation (OA) has emerged. The OA technology may automate office work, and greatly improve working efficiency of individual or group office work.

Specifically, an enterprise may use an OA system (e.g., a business platform and a business system) to assist office work. The OA system typically includes a plurality of business modules that provide different functions, such as an instant messaging module, a form module, a task management module, a conference module, and a schedule management module.

When the user collaborates to work in different business modules in the OA system, if a speech input manner is adopted for content input, a speech input function of the computing device typically needs to be used, such as a speech input method of a mobile terminal of the user. However, a recognition effect of the above speech input function is not good, making it difficult to implement accurate content input.

In view of this, this application provides an information processing method. In the method, a first control associated with a speech input interface is provided, where the speech input interface is displayed with a first text, and the first text is obtained based on conversion of a first speech input. A second text is displayed on the speech input interface in response to an operation associated with the first control, where the second text is obtained by processing the first text based on a processing process corresponding to the first control.

In the method, in a scenario of speech input, by providing the first control associated with the speech input interface, the user may automatically process the first text through the first control based on needs, thereby displaying the processed second text on the speech input interface. Therefore, when a speech recognition effect is not ideal, the user does not need to manually modify the text, thereby effectively improving operation efficiency and interactive experience, and providing the user with accurate and fast information input capabilities.

To facilitate the understanding of the technical solutions provided in the embodiments of this application, the description is made below in conjunction with the accompanying drawings.

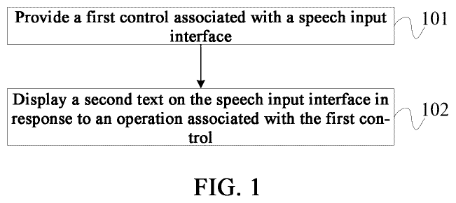

Referring to FIG. 1, which is a schematic flowchart of an information processing method according to an embodiment of this application, the method specifically includes:
S101: Provide a first control associated with a speech input interface.

The speech input interface refers to an interface that supports a speech input function, and the user may input information on the speech input interface in a speech input manner. The speech input interface displays a first text, and the first text is obtained based on conversion of an input first speech. The first speech refers to a speech that is input by the user and is to be subjected to speech recognition. During specific implementation, the first speech may be obtained in response to a speech input operation triggered by the user on the speech input interface.

In different scenarios, the user may trigger the speech input operation in different manners. In some embodiments, the speech input interface loaded by a user device may present a speech input control, and the user may trigger the speech input operation by tapping the speech input control. In some other embodiments, a physical speech input button may be deployed on the user device. When the speech input interface is loaded on the user device, the speech input operation may be triggered by pressing the speech input button.

After the user triggers the speech input operation, speech input may be performed. In some embodiments, the user may continuously trigger the speech input control or continuously press the speech input button to perform speech input. In other words, when the speech input control or the speech input button is in a triggered state, it indicates that the user device is in a speech input state. When the speech input control or the speech input button is in a non-triggered state, for example, the user releases the speech input control or the speech input button, it indicates that the speech input has ended.

In some other embodiments, the user only needs to tap the speech input control once or press the speech input button once to enter the speech input state. In this case, the user may tap the speech input control again, or press the speech input button again to end the speech input. Therefore, a current state of the user device may be obtained in response to the speech input operation triggered by the user on the speech input interface, and when the user device is in the speech input state, the first speech is obtained.

By performing speech recognition on the first speech, the first speech may be converted into the first text. During specific implementation, a speech recognition model may be utilized for obtaining the first text output by the speech recognition model. The speech recognition model is used to recognize and convert the speech.

In some embodiments, the speech recognition model may include an acoustic model and a language model. Specifically, the first speech is first subjected to preprocessing such as de-noising, filtering, and down-sampling, and features such as sound frequency, sound intensity, a speech rate, and stress are extracted. Then, the extracted features are input into the speech recognition model, and the acoustic model is utilized for mapping a speech signal to a phoneme. The language model is then utilized for obtaining a recognized word sequence, and finally, the first text is obtained through matching and decoding.

In some possible implementations, the speech recognition may be started after obtaining the first speech. In some other possible implementations, the speech recognition may be started after completing the input of the first speech. This is not limited in the embodiments of this application.

After the speech recognition, a speech recognition result may be presented to the user, that is, the first text is displayed on the speech input interface. Specifically, the first text may be displayed in an input box of the speech input interface. Accordingly, the user may send, by triggering a send operation, the first text in the input box to a content presentation interface, thereby completing content sending.

In some other possible implementations, the first text may also be directly displayed on the content presentation interface, thereby achieving automatic sending after speech input. During specific implementation, a display area of the first text may be selected in conjunction with a specific scenario. For example, in collaborative scenarios such as instant messaging (IM) and commenting, the first text is often long. In this case, to prevent negative externalities caused by errors in the first text, accuracy of the first text is particularly important. Therefore, for the above scenario where “accuracy is prioritized”, the first text may be displayed on the speech input interface. For another example, in scenarios such as searching and human-machine dialog, the first text is usually short. Therefore, for the above scenario where “efficiency is prioritized”, the first text may be displayed on the content presentation interface (e.g., a search bar or a dialog message bar), namely, adopting a “quick send mode”.

After the speech recognition is completed, the user may have a processing need for the first text. For example, when there are errors in the speech recognition, the user may have a modification need for the first text. For another example, when the user is unsatisfied with wording, tone, a grammatical structure, etc. of the first text, the user may have an optimization need for the first text.

In this embodiment of this application, the first control associated with the speech input interface is provided. Therefore, the user may implement automatic processing (e.g., automatic modification, automatic optimization, and automatic re-editing) on the first text in a manner of subsequently triggering an operation associated with the first control.

The first control may include one or more of the following: a control for invoking a digital assistant interactive interface or a shortcut command control for preset processing. The digital assistant interactive interface refers to an interactive interface that allows the user to achieve human-machine dialog. For example, the digital assistant interactive interface may be provided in the form of a floating window component or a dialog window.

Specifically, the first control may be displayed according to a specific scenario. In some embodiments, the first control may be displayed on the speech input interface. In some other embodiments, considering that the speech input interface may display a large amount of content, to facilitate user viewing, the first control may also be displayed at a position which is located outside the speech input interface and associated with the speech input interface. For example, the first control is displayed on the content presentation interface, thereby achieving an effect of same-screen display.

S102: Display the second text on the speech input interface in response to the operation associated with the first control.

The second text is obtained by processing the first text based on the processing process corresponding to the first control. Operations associated with the first control may indicate different processing needs. In this case, the first text may be processed based on the processing needs to generate the second text. For example, when the processing need indicated by the operation associated with the first control is a grammar modification need, the first text may be processed according to the grammatical modification need, so as to optimize a grammatical logic, thereby generating the second text.

In some possible implementations, the processing process corresponding to the first control may be a processing process based on an artificial intelligence technology. In other words, in this embodiment of this application, the first text is processed through the artificial intelligence technology to automatically generate the second text.

For example, the first text may be processed by a text processing model to generate the second text. In some embodiments, different processing needs may correspond to different models. Therefore, the corresponding text processing model may be called based on the processing need indicated by the operation associated with the first control, thereby generating the second text. In some other embodiments, the text processing model may also be a deep learning model trained using text data. In this case, a statement described in natural language may be generated based on the first text and the processing need. The text processing model analyzes the statement, outputs a response statement for the statement, and uses the response statement as the second text.

Different controls are separately described below. In some embodiments, the first control includes a shortcut command control for preset processing. In this case, the second text may be displayed on the speech input interface in response to a trigger operation on the shortcut command control.

The second text is obtained by processing the first text based on a preset processing process corresponding to the shortcut command control. For example, when the shortcut command control is the grammar modification control, the second text may be obtained by modifying the grammar of the first text. For another example, when the shortcut command control is a smart refine control, the second text may be obtained by refining the first text. In other words, the user may quickly achieve the processing corresponding to the shortcut command control for the first text in a manner of triggering the shortcut command control.

The shortcut command control may be one or more of candidate command controls. For example, the shortcut command control may be a candidate command control historically selected by the user. For another example, the shortcut command control may be a candidate command control that the user uses frequently. For a further example, the shortcut command control may be a candidate command control pre-configured by a configuration personnel. This is not limited in the embodiments of this application.

In some possible implementations, the shortcut command control may include a plurality of sub-controls that can meet more granular processing needs of the user. For example, when the shortcut command control is the smart refine control, the smart refine control may include a plurality of sub-controls to meet different processing needs of the user for the first text (e.g., making it more lively, more straightforward, and more confident).

In the embodiments of this application, switching between the plurality of sub-controls is supported. During specific implementation, the shortcut command control may include a first sub-control and a second sub-control. In response to a trigger operation for the first sub-control, the second text is displayed on the speech input interface. The second text is obtained by processing the first text based on the processing process corresponding to the first sub-control.

Further, in response to a switching operation for the second sub-control, an updated second text is displayed on the speech input interface. The updated second text is obtained by processing the first text based on the processing process corresponding to the second sub-control. Accordingly, the user may view second texts corresponding to different sub-controls in a manner of control switching.

In some other embodiments, the first control includes a control for invoking the digital assistant interactive interface. In this case, the digital assistant interactive interface may be displayed in response to the trigger operation for the first control, and provides a plurality of candidate command controls. The second text is displayed on the speech input interface in response to a trigger operation for a target command control from the plurality of candidate command controls, and the second text is obtained by processing the first text based on a processing process corresponding to the target command control. In other words, the digital assistant interactive interface provides a plurality of options. In other words, the user may select, according to the processing need, the needed target command control from the plurality of candidate command controls provided by the digital assistant interactive interface, thereby processing the first text so as to meet the processing need.

When the user performs speech input in a specific business scenario of a specific business module in a business platform, candidate command controls may be provided for the user in conjunction with the type of the business scenario. Specifically, information of a business scenario to which the speech input interface belongs is obtained in response to the trigger operation for the first control, and the digital assistant interactive interface is displayed. The digital assistant interactive interface provides a plurality of candidate command controls corresponding to the business scenario to which the speech input interface belongs.

In this embodiment of this application, considering that different business modules in the business platform may provide different business functions, in order to process the first text in a targeted manner, candidate command controls corresponding to the business scenarios in the business modules may be provided to the user. For example, when the business module where the speech input interface is the IM module, because a text in a dialog business scenario of the IM module is typically a chat message, the candidate command control corresponding to the dialog business scenario may include a smart refine control, a tone adjusting control, and a grammar modification control. For another example, when the business module to which the speech input interface belongs is a document file, because a text in a document business scenario is typically a text content, the candidate command control corresponding to the document module may include an expansion control, a continuation control, a summary control, and an abbreviation control. In addition, the candidate command control may also be a real-time error correction control, etc.

In some other embodiments, the first control includes a control for invoking the digital assistant interactive interface, and the user may also trigger the processing of the first text in a manner of inputting natural language. Specifically, in response to the trigger operation for the first control, the digital assistant interactive interface is displayed and is used to receive a content input by the user. In response to an input operation on the digital assistant interactive interface, the second text is displayed on the speech input interface, the second text is obtained by processing the first text based on the processing process indicated by the input content of the digital assistant interactive interface, and the input content is described in natural language.

In other words, the user may input, through the digital assistant interface, the input content described in natural language to indicate the processing need, thereby correspondingly processing the first text and generating the second text. For example, the input content may be “help me refine the text.” The processing process indicated by the input content is a refining process, and in this case, the second text may be generated by refining the first text.

In addition, the user may also select the text that needs to be processed. During specific implementation, in response to a selection operation for the first text, the selected first text is displayed on the speech input interface in a preset display manner (e.g., highlighted display). In response to the operation associated with the first control, the second text is displayed on the speech input interface. The second text is obtained by processing the selected first text based on the processing process corresponding to the first control.

In this embodiment of this application, the user may select a text to be processed from the first text, such as a sentence or paragraph requiring grammar modification. For example, only the first text selected by the user may be processed, thereby improving text processing efficiency, and meeting diverse processing needs of the user.

After the processing of the first text is completed, the second text is displayed on the speech input interface, and the user may operate the second text. Specifically, the first text may be displayed in a first area (e.g., an input box) of the speech input interface. In response to a replacement operation, the second text is displayed in the first area of the speech input interface, or in response to an insertion operation, the first text and the second text are displayed in the first area of the speech input interface. Therefore, the first text is replaced with the second text, or the second text is added after the first text.

For example, when the processing need of the user is refining, the replacement operation for the second text may be triggered to achieve text optimization. For another example, when the processing need of the user is continuation, the insertion operation for the second text may be triggered to enrich the text.

Further, when the second text does not meet the processing need of the user, the user may also trigger a retry operation or an abandon operation for the second text, thereby regenerating or abandoning the second text.

In the information processing method provided in this embodiment of this application, the speech input function and an automatic processing function for the first text may be decoupled. In other words, the speech input function and the automatic processing function for the first text may be used as separate software development kits (SDKs) into different business modules, such as a document module, a task module, and a search module, thereby improving the user input efficiency in the different business modules.

Based on the above content description, an embodiment of this application provides an information processing method. In the method, a first control associated with a speech input interface is provided, where the speech input interface displays a first text, and the first text is obtained based on conversion of an input first speech. A second text is displayed on the speech input interface in response to an operation associated with the first control, where the second text is obtained by processing the first text based on a processing process corresponding to the first control.

In the method, in a scenario of speech input, by providing the first control associated with the speech input interface, the user may automatically process the first text through the first control based on needs, thereby displaying the processed second text on the speech input interface. Therefore, when a speech recognition effect is not ideal, the user does not need to manually modify the text, thereby effectively improving operation efficiency and interactive experience, and providing the user with accurate and fast information input capabilities.

Next, the information processing method provided in this application is described in conjunction with specific application scenarios.

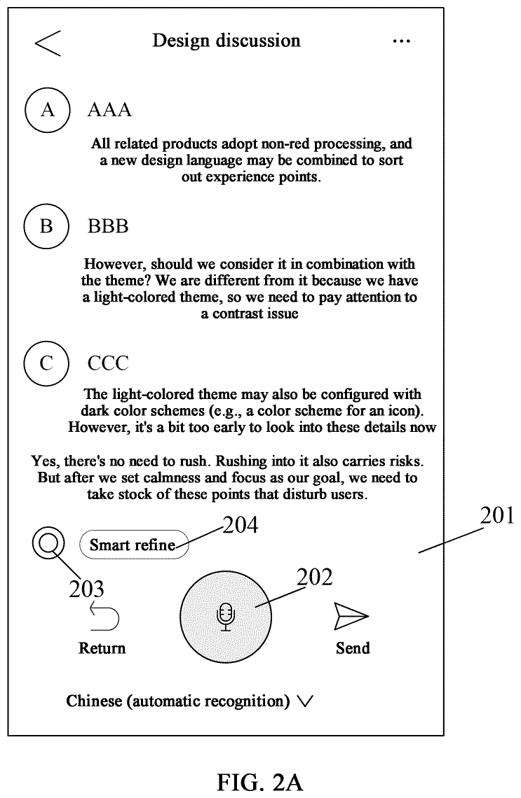

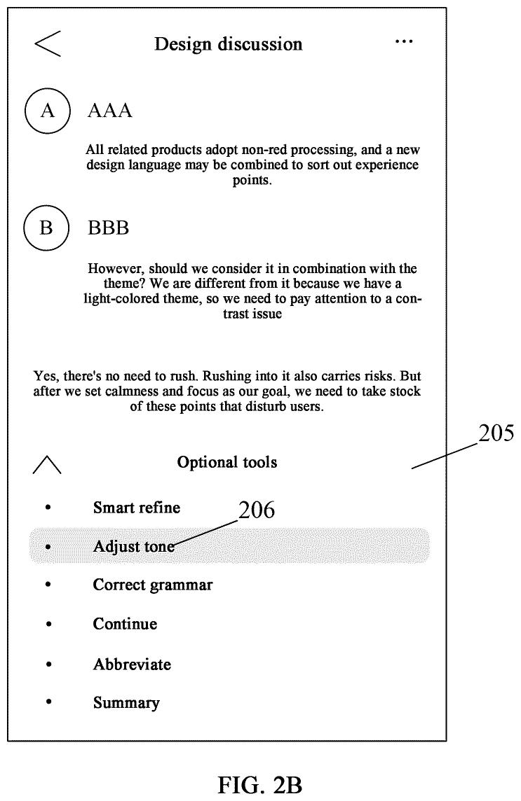

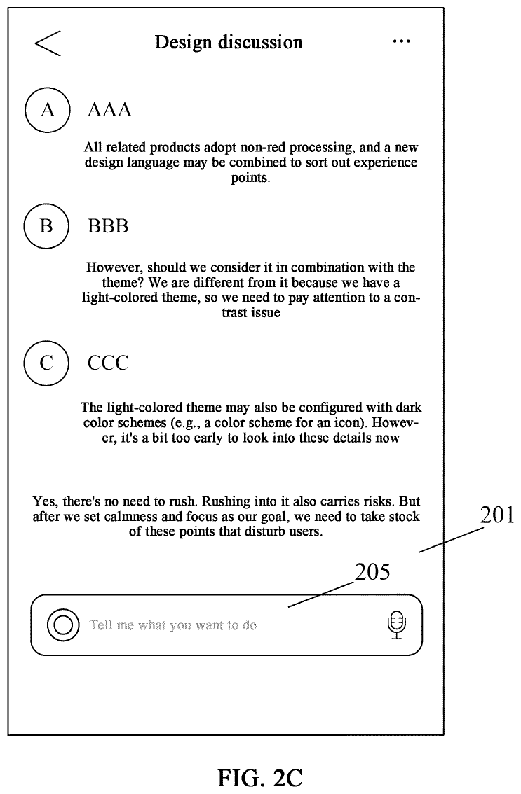

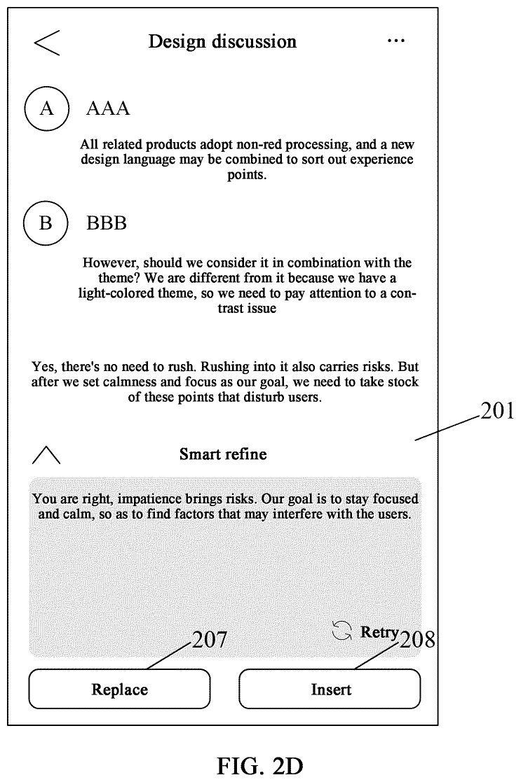

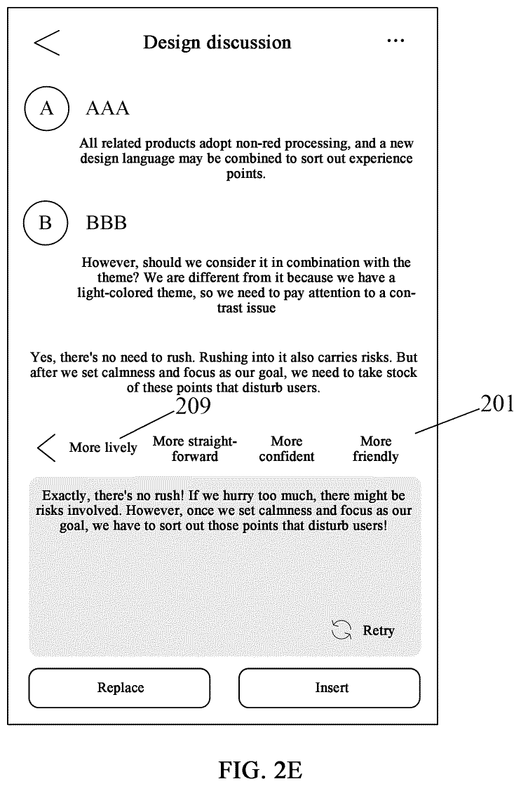

Referring to a schematic diagram of a speech input interface shown in FIG. 2A, the speech input interface 201 supports the user to perform speech input. For example, the user may tap a speech input control 203 provided by the speech input interface 201 to trigger a speech input operation. A first text may be obtained in response to the speech input operation, and is subjected to speech recognition, and after the speech recognition is completed, the first text may be displayed on the speech input interface 201, for example, the first text is displayed in an input box of the speech input interface.

The speech input interface 201 provides a first control. The first control includes a control 203 for invoking a digital assistant interactive interface and a shortcut command control 204 for preset processing. In FIG. 2A, the shortcut command control 204 for preset processing is a smart refine control. When the processing need of the user is smart refine, smart refine of the first text may be achieved in a manner of using the shortcut command control 204 for preset processing.

When the processing need of the user is not smart refine, by triggering the control 203 for invoking the digital assistant interactive interface, the processing of the first text may be triggered in a manner of inputting natural language or selecting a target command control. As shown in FIG. 2B, in response to a trigger operation for the control 203 for invoking the digital assistant interactive interface, the digital assistant interactive interface 205 is displayed. A plurality of candidate command controls 206 are provided in the digital assistant interactive interface 205, such as a smart refine control, a tone adjusting control, a grammar modification control, a continuation control, an abbreviation control, and a summary control. The user may select a target command control meeting the processing need from the plurality of candidate command controls 206, thereby processing the first text.

As shown in FIG. 2C, in response to the trigger operation for the control 203 for invoking the digital assistant interactive interface, the digital assistant interactive interface 205 is displayed, and is used to receive a content input by the user. The user may input the input content described in natural language on the digital assistant interactive interface 205 to indicate the processing need using the input content, thereby processing the first text.

As shown in FIG. 2D, after the processing of the first text is completed, the second text is displayed on the speech input interface 201. In this case, the second text is obtained by processing the first text based on the processing process corresponding to the smart refine control.

After the user views the second text on the speech input interface 201, a related operation may be performed on the second text. Specifically, the speech input interface 201 provides a replacement control 207 and an insertion control 208. The user may replace the first text with the second text by triggering the replacement control 207, or may insert the second text after the first text by triggering the insertion control 208. The user may also trigger a retry operation on the second text through a retry control provided on the speech input interface 201 to regenerate the second text.

In some possible implementations, the shortcut command control 204 for preset processing may include a plurality of sub-controls. As shown in FIG. 2E, a plurality of sub-controls 209 may be displayed on the speech input interface 201, such as making the plurality of sub-controls in the smart refine control more lively, more straightforward, more confident, and more friendly. The user may switch the plurality of sub-controls 209, and the speech input interface 201 may display the second text corresponding to the selected sub-control 209.

The information processing method provided by this embodiment of this application is introduced in detail above in conjunction with FIG. 1 and FIG. 2. A system and a device provided in embodiments of this application are introduced in conjunction with the accompanying drawings.

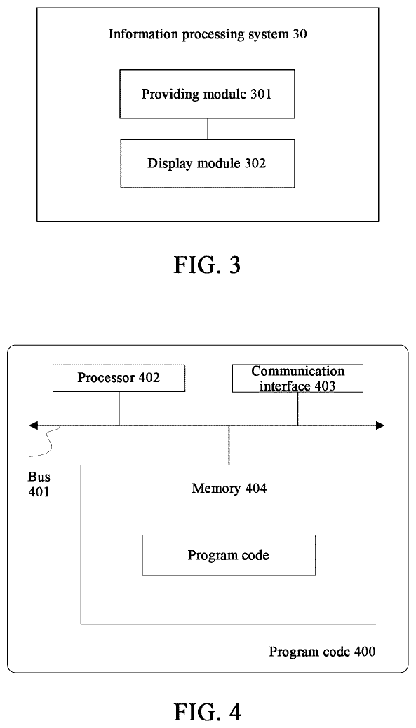

Referring to a structural schematic diagram of an information processing system shown in FIG. 3, the system 30 includes:

a providing module 301, configured to provide a first control associated with a speech input interface, where the speech input interface is displayed with a first text, and the first text is obtained by converting a first speech input; and

a display module 302, configured to display a second text on the speech input interface in response to an operation associated with the first control, where the second text is obtained by processing the first text based on a processing process corresponding to the first control.

In some possible implementations, the processing process corresponding to the first control is a processing process based on an artificial intelligence technology.

In some possible implementations, the first control includes one or more of the following:
a control for invoking a digital assistant interactive interface; and
a shortcut command control for preset processing.

In some possible implementations, the first control includes a shortcut command control for preset processing. The display module 302 is specifically configured to:
display the second text on the speech input interface in response to a trigger operation for the shortcut command control, wherein the second text is obtained by processing the first text based on a preset processing process corresponding to the shortcut command control.

In some possible implementations, the shortcut command control includes a first sub-control and a second sub-control. The display module 302 is specifically configured to:
display the second text on the speech input interface in response to a trigger operation for the first sub-control, wherein the second text is obtained by processing the first text based on a processing process corresponding to the first sub-control; and
the display module 302 is further configured to:
display an updated second text on the speech input interface in response to a switching operation for the second sub-control, wherein the updated second text is obtained by processing the first text based on a processing process corresponding to the second sub-control.

In some possible implementations, the first control includes a control for invoking a digital assistant interactive interface. The display module 302 is specifically configured to:
display the digital assistant interactive interface in response to a trigger operation for the first control, wherein the digital assistant interactive interface provides a plurality of candidate command controls; and
display the second text on the speech input interface in response to a trigger operation for a target command control from the plurality of candidate command controls, wherein the second text is obtained by processing the first text based on a processing process corresponding to the target command control.

In some possible implementations, the display module 302 is specifically configured to:
obtain, in response to the trigger operation for the first control, information of a business scenario to which the speech input interface belongs; and
display the digital assistant interactive interface, wherein the digital assistant interactive interface provides a plurality of candidate command controls corresponding to the business scenario to which the speech input interface belongs.

In some possible implementations, the first control includes a control for invoking a digital assistant interactive interface. The display module 302 is specifically configured to:
display the digital assistant interactive interface in response to a trigger operation for the first control, wherein the digital assistant interactive interface is used to receive a content input by a user; and
display the second text on the speech input interface in response to an input operation on the digital assistant interactive interface, wherein the second text is obtained by processing the first text based on a processing process indicated by an input content on the digital assistant interactive interface, and the input content is described in natural language.

In some possible implementations, the first text is displayed in a first area of the speech input interface, and the display module 302 is further configured to:
display the second text in the first area of the speech input interface in response to a replacement operation; or
display the first text and the second text in the first area of the speech input interface in response to an insertion operation.

In some possible implementations, the display module 302 is further configured to:
display a selected first text on the speech input interface in a set display manner in response to a selection operation for the first text; and
the display module 302 is specifically configured to:
display the second text on the speech input interface in response to the operation associated with the first control, wherein the second text is obtained by processing the selected first text based on the processing process corresponding to the first control.

The information processing system 30 according to this embodiment of this application may be applied to perform the method described in this embodiment of this application. The above and other operations and/or functions of various modules/units of the information processing system 30 respectively implement corresponding processes of various methods in the embodiment shown in FIG. 1. For brevity, details are not described herein again.

An embodiment of this application further provides an electronic device. The electronic device is specifically used to implement the functions of the information processing system 30 in the embodiment shown in FIG. 3.

FIG. 4 provides a structural schematic diagram of an electronic device 400. As shown in FIG. 4, the electronic device 400 includes a bus 401, a processor 402, a communication interface 403, and a memory 404. The processor 402, the memory 404, and the communication interface 403 are in communication through the bus 401.

The bus 401 may be a peripheral component interconnect (PCI) bus or an extended industry standard architecture (EISA) bus. The bus may be divided into an address bus, a data bus, a control bus, and etc. To facilitate representation, only one bold line is used in FIG. 4 for representation, but it does not imply that there is only one bus or one type of bus.

The processor 402 may be any one or more of processors such as a central processing unit (CPU), a graphics processing unit (GPU), a micro processor (MP), or a digital signal processor (DSP).

The communication interface 403 is used for external communication. For example, the communication interface 403 may be used to communicate with a terminal.

The memory 404 may include a volatile memory, such as a random access memory (RAM). The memory 404 may also include a non-volatile memory, such as a read-only memory (ROM), a flash memory, a hard disk drive (HDD), or a solid state drive (SSD).

The memory 404 stores executable code, and the processor 402 executes the executable code to perform the above information processing methods.

Specifically, in the case of implementing the embodiment shown in FIG. 3, and implementing the various modules or the units of the information processing system 30 described in the embodiment in FIG. 3 through software, software or program code required to execute the functions of the various modules/units in FIG. 3 may be partially or completely stored in the memory 404. The processor 402 executes the program code corresponding to each unit stored in the memory 404 to perform the above information processing method.

An embodiment of this application further provides a non-transitory computer-readable storage medium. The computer-readable storage medium may be any available medium that a computing device can store, or a data storage device such as a data center including one or more available media. The available medium may be a magnetic medium (e.g., a floppy disk, a hard drive, and a magnetic tape), an optical medium (e.g., a DVD), or a semiconductor medium (e.g., a solid state drive). The computer-readable storage medium includes instructions. The instructions indicate the computing device to perform the information processing method applied to the information processing system 30.

An embodiment of this application further provides a computer program product. The computer program product includes one or more computer instructions. When the computer instructions are loaded and executed on the computing device, the processes or the functions described in the embodiments of this application are completely or partially generated.

The computer instructions may be stored in the computer-readable storage medium or transmitted from one computer-readable storage medium to another computer-readable storage medium. For example, the computer instructions may be transmitted from a website, a computer, or a data center to another website, computer, server, or data center in a wired (e.g., a coaxial cable, an optical fiber, a digital subscriber line (DSL)) or wireless (e.g., infrared, wireless, and microwave) manner.

When the computer program product is executed by a computer, the computer performs any of the above information processing methods. The computer program product may be a software installation package. When any of the above information processing methods needs to be used, the computer program product may be downloaded and executed on the computer.

The flowcharts and the block diagrams in the accompanying drawings illustrate the possibly implemented system architecture, functions, and operations of the system, the method, and the computer program product according to the various embodiments of this application. In this regard, each block in the flowcharts or the block diagrams may represent a module, a program segment, or a part of code, and the module, the program segment, or the part of code includes one or more executable instructions for implementing specified logic functions. It should also be noted that in some alternative implementations, the functions marked in the blocks may also occur in an order different from that marked in the accompanying drawings.

For example, two blocks shown in succession may actually be performed substantially in parallel, or may sometimes be performed in a reverse order, depending on functions involved. It should also be noted that each block in the block diagrams and/or the flowcharts, and a combination of the blocks in the block diagrams and/or the flowcharts may be implemented by using a dedicated hardware-based system that performs specified functions or operations, or may be implemented by using a combination of dedicated hardware and computer instructions.

The units described and involved in the embodiments of this application may be implemented through software or hardware. The name of the unit/module does not limit the unit in certain cases.

Herein, the functions described above may be at least partially executed by one or more hardware logic components. For example, without limitation, exemplary hardware logic components that can be used include: a field-programmable gate array (FPGA), an application specific integrated circuit (ASIC), an application specific standard part (ASSP), a system on chip (SOC), a complex programmable logic device (CPLD), etc.

In the context of the embodiments of this application, a machine-readable medium may be a tangible medium that may include or store a program for use by or for use in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include an electrical connection based on one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above content.

It should be noted that the various embodiments in the specification are described in a progressive manner, highlighting the differences between each embodiment and the other embodiments. The similar or identical parts between different embodiments may be cross-referenced to each other. The system or apparatus disclosed by the embodiment corresponds to the method disclosed by the embodiment, and therefore, the description is simple, and for associated parts, reference is made to part of the description of the method.

It should be understood that in this application, “at least one” means one or more, and “a plurality of” means two or more. The term “and/or” is an association relationship for describing associated objects, indicating that there may be three relationships, for example, “A and/or B” may represent three situations: A exists alone, B exists alone, and both A and B exist, where A and B may be singular or plural. The character “/” generally indicates an “or” relationship between preceding and succeeding associated objects. “At least one of the following” or similar expressions thereof refer to any combination of these items, including any combination of single or plural items. For example, at least one of a, b, or c may represent: a, b, c, “a and b”, “a and c”, “b and c”, or “a, b, and c”, where a, b, and c may be single or plural.

It should be further noted that herein, relational terms such as first and second are used only to distinguish one entity or operation from another and do not necessarily require or imply any actual relationship or order between these entities or operations. In addition, the terms “comprise”, “include”, or any other variations thereof are intended to cover non-exclusive inclusion, and therefore a process, a method, an article, or a device including a series of elements not only includes those elements but also includes other elements not clearly listed, or further includes elements inherent to the process, the method, the article, or the device. In the absence of further restrictions, an element specified by the phrase “including a . . . ” does not exclude the existence of other identical elements in the process, the method, the article, or the device that includes the element.

The method or algorithm steps described in the embodiments disclosed herein may be implemented directly by hardware, a software module executed by the processor, or a combination of both. The software module may be arranged in the random access memory (RAM), an internal memory, a read-only memory (ROM), an electrically programmable ROM, an electrically erasable programmable ROM, a register, a hard drive, a removable disk, a CD-ROM, or any other form of storage medium known in the technical field.

Those skilled in the art can implement or use this application according to the above descriptions of the disclosed embodiments. More modifications for the embodiments are apparent to those skilled in the art, and general principles defined herein may be implemented in other embodiments without departing from the spirit or scope of this application. Therefore, this application will not be limited to the embodiments shown herein but needs to conform to a widest scope consistent to the principles and novel characteristics disclosed herein.

I/We claim:

1. An information processing method, comprising:
providing a first control associated with a speech input interface, wherein the speech input interface is displayed with a first text, and the first text is obtained by converting a first speech input; and
displaying a second text on the speech input interface in response to an operation associated with the first control, wherein the second text is obtained by processing the first text based on a processing process corresponding to the first control.

2. The method according to claim 1, wherein
the processing process corresponding to the first control is a processing process based on an artificial intelligence technology.

3. The method according to claim 1, wherein the first control comprises one or more of:
a control for invoking a digital assistant interactive interface; and
a shortcut command control for preset processing.

4. The method according to claim 1, wherein the first control comprises a shortcut command control for preset processing, and displaying the second text on the speech input interface in response to the operation associated with the first control comprises:
displaying the second text on the speech input interface in response to a trigger operation for the shortcut command control, wherein the second text is obtained by processing the first text based on a preset processing process corresponding to the shortcut command control.

5. The method according to claim 4, wherein the shortcut command control comprises a first sub-control and a second sub-control, and displaying the second text on the speech input interface in response to the trigger operation for the shortcut command control comprises:
displaying the second text on the speech input interface in response to a trigger operation for the first sub-control, wherein the second text is obtained by processing the first text based on a processing process corresponding to the first sub-control; and
wherein the method further comprises:
displaying an updated second text on the speech input interface in response to a switching operation for the second sub-control, wherein the updated second text is obtained by processing the first text based on a processing process corresponding to the second sub-control.

6. The method according to claim 1, wherein the first control comprises a control for invoking a digital assistant interactive interface, and displaying the second text on the speech input interface in response to the operation associated with the first control comprises:
displaying the digital assistant interactive interface in response to a trigger operation for the first control, wherein the digital assistant interactive interface provides a plurality of candidate command controls; and
displaying the second text on the speech input interface in response to a trigger operation for a target command control from the plurality of candidate command controls, wherein the second text is obtained by processing the first text based on a processing process corresponding to the target command control.

7. The method according to claim 6, wherein displaying the digital assistant interactive interface in response to the trigger operation for the first control comprises:
obtaining, in response to the trigger operation for the first control, information of a business scenario to which the speech input interface belongs; and
displaying the digital assistant interactive interface, wherein the digital assistant interactive interface provides a plurality of candidate command controls corresponding to the business scenario to which the speech input interface belongs.

8. The method according to claim 1, wherein the first control comprises a control for invoking a digital assistant interactive interface, and displaying the second text on the speech input interface in response to the operation associated with the first control comprises:
displaying the digital assistant interactive interface in response to a trigger operation for the first control, wherein the digital assistant interactive interface is used to receive a content input by a user; and
displaying the second text on the speech input interface in response to an input operation on the digital assistant interactive interface, wherein the second text is obtained by processing the first text based on a processing process indicated by an input content on the digital assistant interactive interface, and the input content is described in natural language.

9. The method according to claim 1, wherein the first text is displayed in a first area of the speech input interface, and the method further comprises:
displaying the second text in the first area of the speech input interface in response to a replacement operation; or
displaying the first text and the second text in the first area of the speech input interface in response to an insertion operation.

10. The method according to claim 1, further comprising:
displaying a selected first text on the speech input interface in a set display manner in response to a selection operation for the first text; and
wherein displaying the second text on the speech input interface in response to the operation associated with the first control comprises:
displaying the second text on the speech input interface in response to the operation associated with the first control, wherein the second text is obtained by processing the selected first text based on the processing process corresponding to the first control.

11. An electronic device, wherein the electronic device comprises a processor and a memory, and
the processor is configured to execute instructions stored in the memory to cause the electronic device to:
provide a first control associated with a speech input interface, wherein the speech input interface is displayed with a first text, and the first text is obtained by converting a first speech input; and
display a second text on the speech input interface in response to an operation associated with the first control, wherein the second text is obtained by processing the first text based on a processing process corresponding to the first control.

12. The electronic device according to claim 11, wherein
the processing process corresponding to the first control is a processing process based on an artificial intelligence technology.

13. The electronic device according to claim 11, wherein the first control comprises one or more of:
a control for invoking a digital assistant interactive interface; and
a shortcut command control for preset processing.

14. The electronic device according to claim 11, wherein the first control comprises a shortcut command control for preset processing, and the instructions causing the electronic device to display the second text on the speech input interface in response to the operation associated with the first control comprise instructions causing the electronic device to:
display the second text on the speech input interface in response to a trigger operation for the shortcut command control, wherein the second text is obtained by processing the first text based on a preset processing process corresponding to the shortcut command control.

15. The electronic device according to claim 14, wherein the shortcut command control comprises a first sub-control and a second sub-control, and the instructions causing the electronic device to display the second text on the speech input interface in response to the trigger operation for the shortcut command control comprise instructions causing the electronic device to:
display the second text on the speech input interface in response to a trigger operation for the first sub-control, wherein the second text is obtained by processing the first text based on a processing process corresponding to the first sub-control; and
wherein the memory further stores instructions causing the electronic device to:
display an updated second text on the speech input interface in response to a switching operation for the second sub-control, wherein the updated second text is obtained by processing the first text based on a processing process corresponding to the second sub-control.

16. The electronic device according to claim 11, wherein the first control comprises a control for invoking a digital assistant interactive interface, and the instructions causing the electronic device to display the second text on the speech input interface in response to the operation associated with the first control comprise instructions causing the electronic device to:
display the digital assistant interactive interface in response to a trigger operation for the first control, wherein the digital assistant interactive interface provides a plurality of candidate command controls; and
display the second text on the speech input interface in response to a trigger operation for a target command control from the plurality of candidate command controls, wherein the second text is obtained by processing the first text based on a processing process corresponding to the target command control.

17. The electronic device according to claim 16, wherein the instruction causing the electronic device to display the digital assistant interactive interface in response to the trigger operation for the first control comprise instructions causing the electronic device to:
obtain, in response to the trigger operation for the first control, information of a business scenario to which the speech input interface belongs; and
display the digital assistant interactive interface, wherein the digital assistant interactive interface provides a plurality of candidate command controls corresponding to the business scenario to which the speech input interface belongs.

18. The electronic device according to claim 11, wherein the first control comprises a control for invoking a digital assistant interactive interface, and the instructions causing the electronic device to display the second text on the speech input interface in response to the operation associated with the first control comprise instructions causing the electronic device to:
display the digital assistant interactive interface in response to a trigger operation for the first control, wherein the digital assistant interactive interface is used to receive a content input by a user; and
display the second text on the speech input interface in response to an input operation on the digital assistant interactive interface, wherein the second text is obtained by processing the first text based on a processing process indicated by an input content on the digital assistant interactive interface, and the input content is described in natural language.

19. The electronic device according to claim 11, wherein the first text is displayed in a first area of the speech input interface, and the memory further stores instructions causing the electronic device to:
display the second text in the first area of the speech input interface in response to a replacement operation; or
display the first text and the second text in the first area of the speech input interface in response to an insertion operation.

20. A non-transitory computer-readable storage medium, comprising instructions, wherein the instructions instruct the electronic device to:
provide a first control associated with a speech input interface, wherein the speech input interface is displayed with a first text, and the first text is obtained by converting a first speech input; and
display a second text on the speech input interface in response to an operation associated with the first control, wherein the second text is obtained by processing the first text based on a processing process corresponding to the first control.
